(19) United States
(12) Patent Application Publication
(10) Pub. No.: US 2022/0058657 A1
(43) Pub. Date: Feb. 24, 2022

(54) NON-TRANSITORY COMPUTER-READABLE STORAGE MEDIUM FOR STORING INFORMATION PROCESSING PROGRAM, INFORMATION PROCESSING METHOD, AND INFORMATION PROCESSING APPARATUS

(71) Applicant: FUJITSU LIMITED, Kawasaki-shi (JP)

(72) Inventor: Susumu Koga, Kawasaki (JP)

(73) Assignee: FUJITSU LIMITED, Kawasaki-shi (JP)

(21) Appl. No.: 17/330,888

(22) Filed: May 26, 2021

(30) Foreign Application Priority Data
Aug. 19, 2020 (JP) 2020-138882

(51) Int. Cl. G06Q 30/00; G06F 11/34

(52) U.S. Cl. CPC G06Q 30/018; G06F 11/3419; G06Q 30/016

(57) ABSTRACT

A non-transitory computer-readable storage medium storing an information processing program for causing a computer to execute processing, the processing including: notifying a second terminal of inquiry information that includes an inquiry received from a first terminal; storing, when an answer to the inquiry information is received from the second terminal, the inquiry and the answer in association with each other in a storage unit; and transmitting notification information that includes the inquiry and the answer in association with each other to a third terminal different from the first terminal and the second terminal.

### CROSS-REFERENCE TO RELATED APPLICATION

This application is based upon and claims the benefit of priority of the prior Japanese Patent Application No. 2020-138882, filed on Aug. 19, 2020, the entire contents of which are incorporated herein by reference.

### FIELD

The embodiments discussed herein are related to a non-transitory computer-readable storage medium storing an information processing program, an information processing method, and an information processing apparatus.

### BACKGROUND

In recent years, robotic process automation (RPA) has attracted attention. RPA is a mechanism in which, for example, various tasks to be performed by using a computer are performed by a robot incorporated in software instead. By introducing RPA, it is possible to cause a robot to execute processing that has been manually performed, and to potentially increase the efficiency of a task and improve productivity.

On the other hand, specialized knowledge is demanded for introduction and operation of RPA. Therefore, a support service that supports the introduction and operation of RPA is provided.

In this regard, a technique related to RPA is known (for example, PTL 1). A technique related to providing an answer to a question is known (for example, PTL 2 and PTL 3).

Examples of the related art include Japanese Laid-open Patent Publication No. 2019-32719, Japanese Laid-open Patent Publication No. 2002-358356, and Japanese Laid-open Patent Publication No. 11-250130.

### SUMMARY

According to an aspect of the embodiments, a non-transitory computer-readable storage medium storing an information processing program for causing a computer to execute processing, the processing including: notifying a second terminal of inquiry information that includes an inquiry received from a first terminal; storing, when an answer to the inquiry information is received from the second terminal, the inquiry and the answer in association with each other in a storage unit; and transmitting notification information that includes the inquiry and the answer in association with each other to a third terminal different from the first terminal and the second terminal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a system configuration of an exemplary RPA support service;

FIG. 2 is a diagram illustrating a support system that provides an operation support service for an RPA system according to an embodiment, as an example;

FIG. 3 is a diagram illustrating a functional block configuration of a support server according to the embodiment, as an example;

FIG. 4 is a diagram illustrating an operation flowchart of processing of providing a support service according to the embodiment, as an example;

FIG. 5 is a diagram illustrating support history information according to the embodiment, as an example;

FIG. 6 is a diagram illustrating notification information according to the embodiment, as an example;

FIGS. 7A to 7C illustrate a diagram illustrating additional information according to the embodiment, as an example;

FIG. 8 is a diagram illustrating a procedure of processing of providing a support service according to the embodiment, as an example; and

FIG. 9 is a diagram illustrating a hardware configuration of a computer that achieves the support server according to the embodiment, as an example.

### DESCRIPTION OF EMBODIMENT(S)

However, for example, an evaluator who evaluates support received from an RPA operation support service by a customer belongs to a purchasing department or the like that manages a budget, and may be different from a person in charge of operating an RPA system who receives the support service. In this case, it may be difficult for the evaluator to evaluate the support service received by the person in charge of operating the RPA system.

In an aspect of the embodiments disclosed below, there is provided a solution to provide the support content of a support service executed in response to an inquiry.

Hereinafter, some embodiments of the present disclosure will be described in detail with reference to the drawings. The corresponding components in a plurality of the drawings are denoted by the same reference signs.

As described above, a support service that supports the introduction and operation of RPA is provided. The support service includes, for example, a service of answering an inquiry about an RPA system from a customer. The inquiry from the customer may include, for example, a demand, a question, a request, and the like related to the RPA system. The answer provided to the inquiry may include, for example, a reply, a response, education, support, and the like to the inquiry.

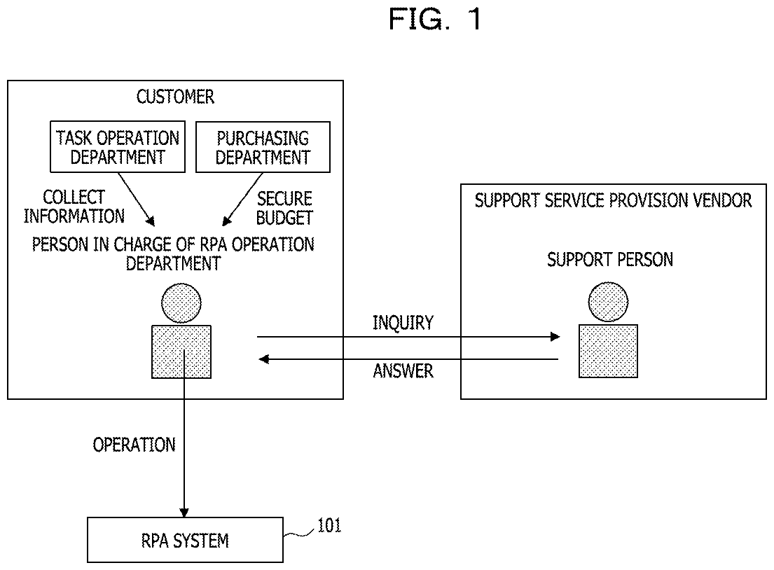

FIG. 1 illustrates a system configuration of an exemplary RPA support service. For example, in a case where a customer causes a robot of an RPA system 101 to execute a task of a task operation department on behalf of the customer, a person in charge of an RPA operation department that operates the RPA system 101 collects task information from the task operation department. The person in charge creates a robot based on the collected task information and operates the RPA system 101. The person in charge also secures a budget for the cost of operating the RPA system 101 from a purchasing department. The cost for operating the RPA system 101 may include, for example, the cost for using the RPA support service according to the embodiment.

For example, in a case where there is a question or the like about the operation of the RPA system 101, the person in charge makes an inquiry to a support person who supports the operation of the RPA system 101 at a support service provision vendor.

Regarding the support service of RPA, a prompt response may be requested, and thus, a customer may want the provision of the support service on-site. On the other hand, there is a shortage of human resources such as engineers who provide RPA technology, and it is difficult to provide on-site support and provide a service for one customer, or the cost becomes high.

In order to effectively utilize human resources, it is preferable to provide technical support to a plurality of customers by remote support rather than on-site support of performing technical support for one customer. In doing so, the cost for the support service may be reduced. In many cases, a sufficient support service may be actually provided even by remote support. Examples of remote support include technical support such as questions and answers (Q & A) support by using e-mail, telephone call, screen sharing of a display screen, and the like.

However, the customer's uneasiness about remote support may not be completely alleviated. For this reason, it is desirable to provide a technique capable of reducing the customer's uneasiness by visualizing and providing results of a support service by the remote support to the customer.

For example, in some cases, evaluation of a value of the support service for the operation of the RPA system 101 provided to the customer may be performed by an evaluator that belongs to the purchasing department or the like that manages the budget for the customer. In this case, since the person in charge of the operation department who receives the provided support service of the RPA system 101 is different from the evaluator, it may be difficult to evaluate the support service. For example, when the evaluator does not accept the value of the support service, the person in charge of the operation department may not use the support service, or the support service provision vendor may not provide the support service to the customer.

For this reason, there is a desire for a technique that makes it possible to provide a support service to the customer in which the result of the operation support by the support service may be visualized.

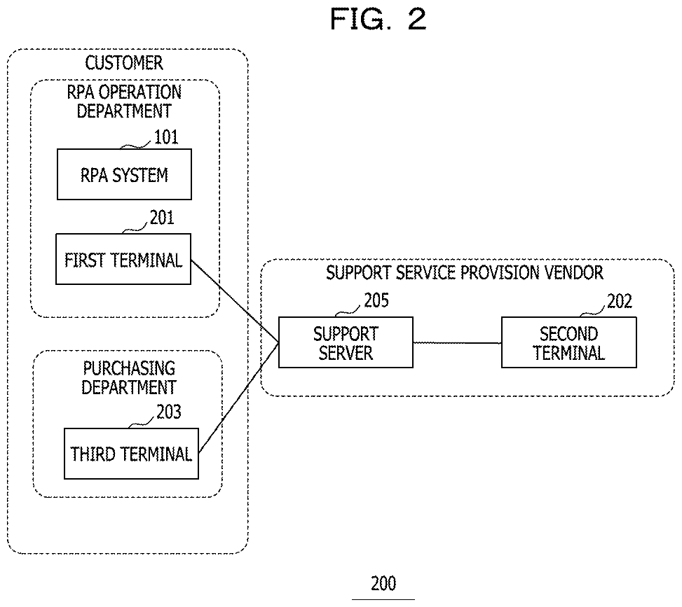

FIG. 2 is a diagram illustrating a support system 200 that supports the operation of the RPA system 101 according to the embodiment, as an example. The support system 200 includes, for example, the RPA system 101, a first terminal 201, a second terminal 202, a third terminal 203, and a support server 205.

The first terminal 201 may be, for example, a terminal to be used by a person in charge of an operation department in charge of operating the RPA system 101 of a customer.

The second terminal 202 may be, for example, a terminal to be used by a support person of the support service provision vendor that provides the operation support service of the RPA system 101.

The third terminal 203 is, for example, a terminal different from the first terminal 201 and the second terminal 202. The third terminal 203 may be, for example, a terminal to be used by the evaluator of the customer who evaluates the RPA support service. For example, the evaluator may belong to the purchasing department that manages the budget for receiving the RPA support service.

The support server 205 is, for example, a server that receives a request for providing a technical support service of the RPA system 101 according to the embodiment.

The first terminal 201, the second terminal 202, and the third terminal 203 may be information processing apparatuses such as a personal computer (PC), a mobile PC, a tablet terminal, a smartphone, a mobile phone, and the like. The RPA system 101 and the support server 205 may be, for example, information processing apparatuses such as a server computer, a personal computer, a mobile computer, and the like.

In the embodiment that will be described below, for example, the support server 205 provides a service of providing technical support for the RPA system 101.

For example, it is assumed that the person in charge of the operation department of the customer operates the first terminal 201 to transmit an inquiry to the support server 205. In this case, for example, the support server 205 notifies the second terminal 202 of inquiry information including the received inquiry.

When the inquiry information is received by the second terminal, the support person of the support service provision vendor operates the second terminal to return answer information including an answer to the inquiry to the support server 205.

When receiving answer information to an inquiry, the support server 205, for example, associates and stores the inquiry and the answer included in the answer information to the inquiry in a storage unit 302. For example, the support server 205 transmits the answer information to the inquiry to the first terminal 201. Thus, the support server 205 may provide support service in response to the inquiry from the customer.

For example, the support server 205 reads, from the storage unit 302, information associating the inquiry from the customer with the answer to the inquiry and notifies the third terminal of the information. The third terminal may be, for example, a terminal to be used by the evaluator who evaluates the support service, such as the purchasing department that manages the budget for the customer, or the like. For example, based on the information that associates the notified inquiry with the answer to the inquiry, the evaluator who uses the third terminal may recognize the content of the support service received by the person in charge of the operation of the RPA system 101 that uses the first terminal.

For example, in a case where the introduction of RPA is promoted from the bottom up by the customer, in order to maintain a budget in order for the customer to receive the support service, there may be a demand to indicate the value of the support service to the evaluator. In such a case, the budget may be easily maintained by notifying the evaluator of the information associating the inquiry with the answer to the inquiry and presenting the content of the support service. Hereinafter, the embodiment will be described in more detail.

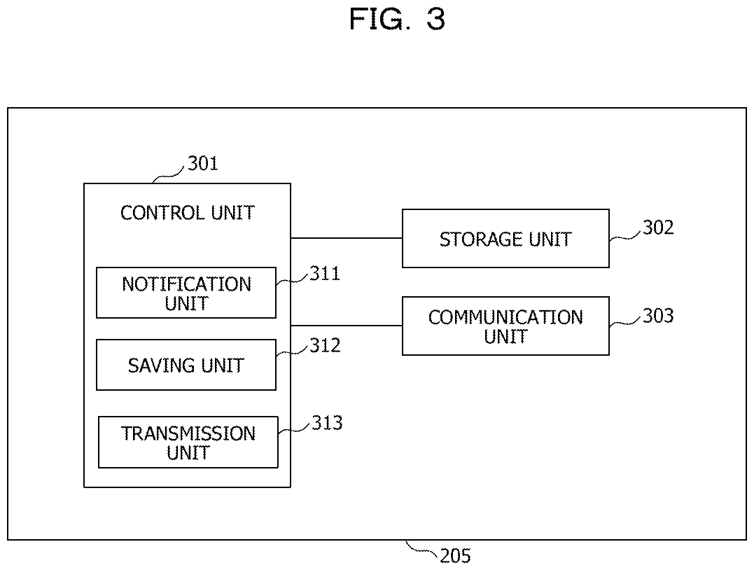

FIG. 3 is a diagram illustrating a functional block configuration of the support server 205 according to the embodiment, as an example. The support server 205 includes, for example, a control unit 301, the storage unit 302, and a communication unit 303. The control unit 301 includes, for example, a notification unit 311, a saving unit 312, a transmission unit 313, and the like, and may include other functional units. The storage unit 302 of the support server 205 stores, for example, information such as support history information 500, notification information 600, on-site support information 701, customer interview information 702, customer interview content information 703, and the like. For example, the communication unit 303 may communicate with other apparatuses such as the first terminal 201, the second terminal 202, and the third terminal 203 in accordance with an instruction from the control unit 301. Each of these units and information stored in the storage unit 302 will be described in detail later.

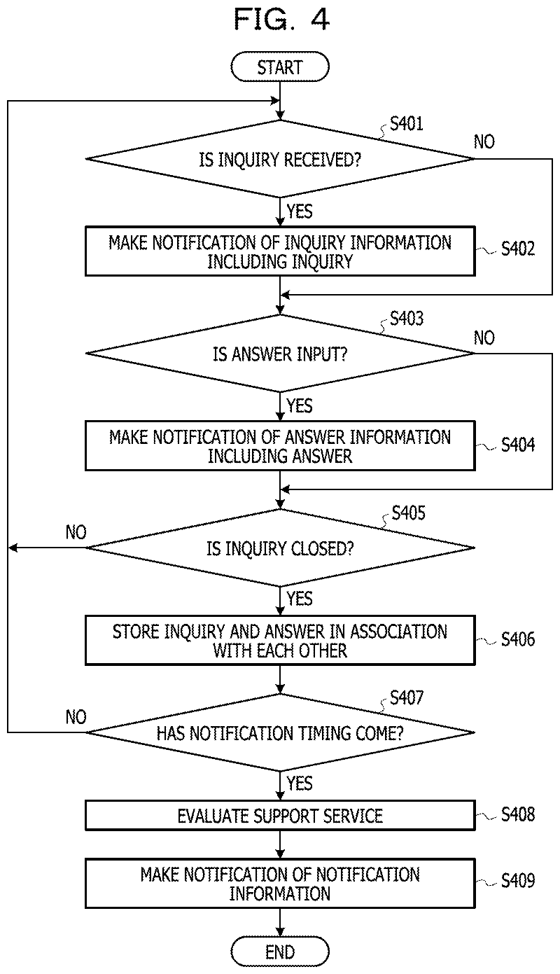

FIG. 4 is a diagram illustrating an operation flowchart of processing of providing a support service according to the embodiment, as an example. For example, when an instruction to execute processing of providing a support service is input, the control unit 301 may start the operation processing in FIG. 4.

In step 401 (hereinafter, each step will be described as “S”, for example, S401), the control unit 301 determines whether or not an inquiry is input. For example, when receiving an inquiry from the first terminal 201, the control unit 301 may determine YES in S401. When the inquiry is not input in S401 (NO in S401), the processing proceeds to S403. On the other hand, when the inquiry is input in S401 (YES in S401), the processing proceeds to S402.

In S402, the control unit 301 notifies the second terminal 202 of inquiry information including the input inquiry.

In S403, the control unit 301 determines whether an answer to the notified inquiry is input from the second terminal 202 or not. For example, when the answer information including the answer to the inquiry is received from the second terminal 202, the control unit 301 may determine YES in S403. When no answer is input in S403 (NO in S403), the processing proceeds to S405. On the other hand, when the answer is input in S403 (YES in S403), the processing proceeds to S404.

In S404, the control unit 301 notifies the first terminal 201 that input the inquiry of the answer information including the input answer. Thereby, the control unit 301 may remotely provide a support service of the RPA system 101 in response to the inquiry.

Subsequently, in S405, the control unit 301 determines whether or not a completion notification for closing the inquiry has been received. For example, when a person in charge that has made the inquiry refers to the answer included in the answer information received by the first terminal 201 and determines that the content of the inquiry has been solved, the person in charge that has made the inquiry may transmit a completion notification for closing the inquiry from the first terminal 201 to the support server 205. When a completion notification for closing the inquiry is not input in S405 (NO in S405), the processing returns to S401 to repeat the process. On the other hand, when a completion notification for closing the inquiry is input in S405 (YES in S405), the processing proceeds to S406.

In S406, the control unit 301 associates and stores the inquiry and the answer to the inquiry in the storage unit 302. For example, the control unit 301 may register a record in which the inquiry and the answer to the inquiry are associated with each other in the support history information 500 and store the record in the storage unit 302.

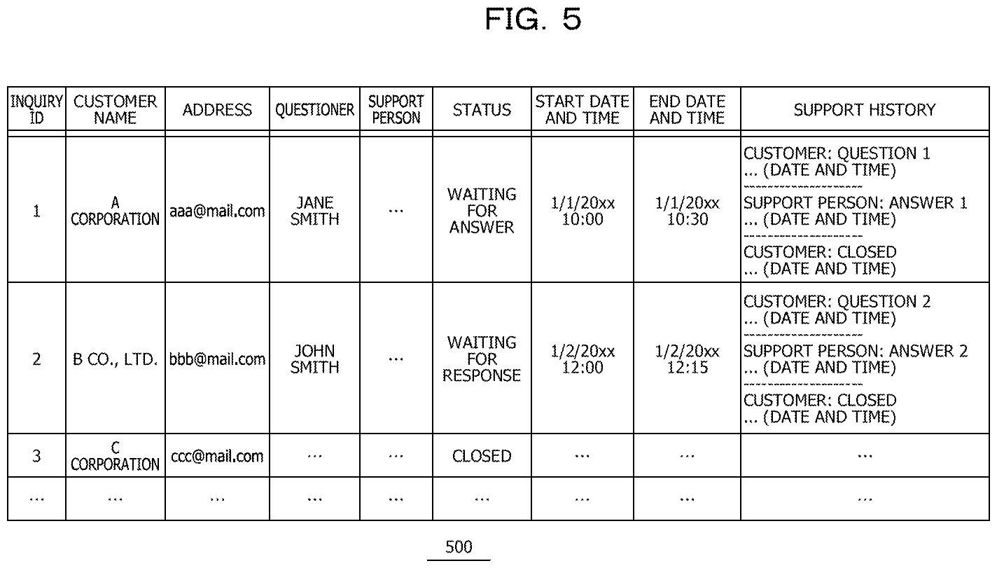

FIG. 5 is a diagram illustrating the support history information 500 according to the embodiment, as an example. In the support history information 500, for example, records are registered in which an inquiry ID, a customer name, an address, a questioner, a support person, a status, a start date and time, an end date and time, support history, and the like are associated with each other.

The inquiry ID is, for example, an identifier for identifying an inquiry received from a customer. The customer name is, for example, a name of the customer who has made the inquiry identified by the inquiry ID of the record. The address is, for example, information indicating an e-mail address of the customer who has made the inquiry identified by the inquiry ID of the record. The questioner is, for example, information indicating a questioner of the customer who has made the inquiry identified by the inquiry ID of the record. The support person may be registered with, for example, information indicating a support person who has provided an answer in a case where the answer to the inquiry identified by the inquiry ID of the record has been provided. The status is, for example, information indicating a status of the inquiry identified by the inquiry ID of the record. FIG. 5 illustrates statuses of waiting for an answer, waiting for a reply, being closed, and the like. For example, the status of being closed is a status in a case where an inquiry is solved and a completion notification for closing the inquiry is input from the customer. In the start date and time, for example, time information indicating a date and time when the inquiry identified by the inquiry ID of the record has been received may be registered. In the end date and time, for example, time information indicating a date and time when the customer has closed the inquiry identified by the inquiry ID of the record may be registered. The support history is, for example, information indicating history of the support service provided to the customer for the inquiry identified by the inquiry ID of the record. In the support history, for example, information about communication between the customer who has made the inquiry and the support person who provides support such as the answer to the inquiry may be registered. In one example, the support history may include exchange history of messages such as a question from the customer and an answer input from the support person to the question. The support history may include, for example, time information indicating a date and time when the question and the answer are notified.

In S407, the control unit 301 determines whether or not a notification timing of the support has come. The notification timing may be set, for example, at predetermined time intervals, and in this case, the control unit 301 may determine YES in S407 when the predetermined time interval elapses. When the notification timing has not come in S407 (NO in S407), the processing returns to S401. On the other hand, when the notification timing has come in S407 (YES in S407), the processing proceeds to S408.

In S408, the control unit 301 evaluates the support service provided to the customer in the past. For example, the control unit 301 extracts a record of an inquiry from a customer to be notified from the support history information 500. The control unit 301 refers to the extracted record of the inquiry from the customer to be notified, and identifies an answer period of time from the start date and time of the inquiry to the end date and time at which the inquiry is closed. The control unit 301 may identify, as an immediate response rate, a rate of the number of records of an inquiry or inquiries whose answer period of time is within a predetermined period of time among the number of the extracted records of the customer to be notified. The immediate response rate is, for example, information indicating a rate at which an inquiry or inquiries of the customer are immediately solved by the support service.

In S409, the control unit 301 extracts, from the support history information 500, information about the record of the inquiry from the customer to be notified, generates the notification information 600, and transmits the notification information to the third terminal 203, after which the operation processing ends.

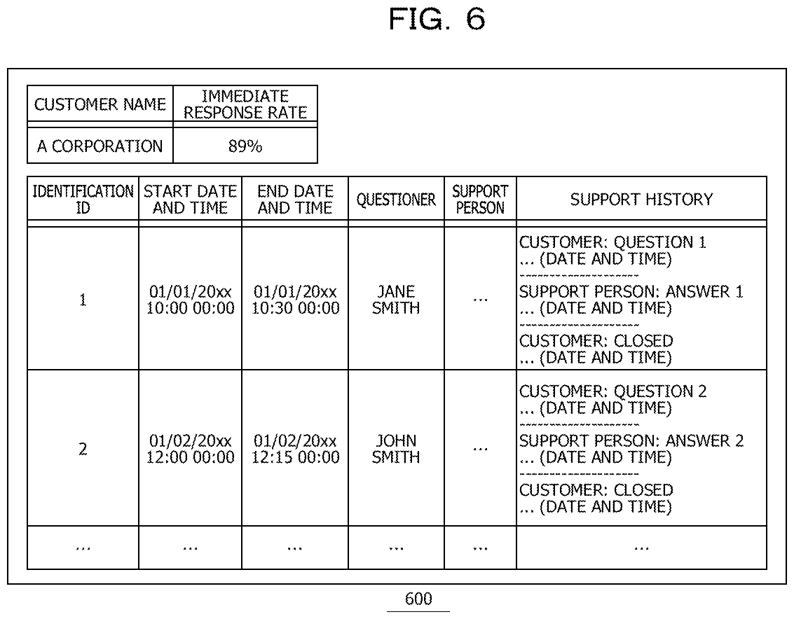

FIG. 6 is a diagram illustrating the notification information 600 according to the embodiment, as an example. In FIG. 6, the notification information 600 includes, for example, information about the customer name and the immediate response rate. The customer name is, for example, information indicating the customer who is to be notified of the notification information 600. The immediate response rate is, for example, information indicating a rate of the number of an inquiry or inquiries that have been immediately responded to among the number of inquiries from the customer who is to be notified of the notification information 600.

In the notification information 600, for example, a record in which an identification ID, a start date and time, an end date and time, a questioner, a support person, and support history are associated with each other is registered.

The identification ID is, for example, an identifier identifying an inquiry received from the customer who is to be notified of the notification information 600. For example, information about the start date and time, the end date and time, the questioner, the support person, and the support history of the extracted record of the customer to be notified from the support history information 500 may be respectively registered in the start date and time, the end date and time, the questioner, the support person, and the support history of the notification information 600.

Thus, for example, the evaluator of the support service may refer to the notification information 600 in which the third terminal 203 is notified to easily recognize the content of the support service provided by the support person of the second terminal 202. As a result, the evaluator may easily recognize the value of the support service.

The customer may identify the answer period of time, for example, from the time information included in the notification information 600. In one example, the answer period of time may be a period of time that it takes to receive the answer information including the answer corresponding to the inquiry after the inquiry is received. For example, in FIG. 6, the notification information 600 includes, in a column of the support history, the time information indicating a date and time when the inquiry is received and a date and time when the answer information to the inquiry is received. From the time information, it is possible to identify the answer period of time that it takes to obtain the answer to the inquiry at the first time. For this reason, for example, by referring to the notification information 600, the customer may know that the answer to the inquiry has been quickly obtained even by remote support.

In another example, the answer period of time may be a period of time from the reception of the inquiry until the inquiry is closed. For example, in FIG. 6, the notification information 600 includes the start date and time and the end date and time as time information. Based on these pieces of time information, it is possible to identify the answer period of time from the reception of the inquiry until the inquiry is closed. For this reason, for example, by referring to the notification information 600, it is possible to know that the inquiry has been quickly solved even by remote support.

In the above-described embodiment, the notification information 600 includes the immediate response rate. For this reason, for example, the person in charge of the operation of the RPA system 101 who receives the support service may know that sufficiently quick support may be received even by remote support, from the value of the immediate response rate.

Thus, the customer may evaluate the support content of the support service by referring to the notification information 600, and may use the support service by remote support without anxiety.

An example has been described above in which the information registered in the support history information 500 is provided to the customer as the notification information 600, and is used to notify the customer of the support content of the support service, but the embodiment is not limited thereto. For example, in another embodiment, the information registered in the support history information 500 may be used for the evaluation of the quality of the support service provided by the support person of the support service provision vendor, or the like.

FIG. 6 illustrates an example in which the notification information 600 includes the inquiry and the answer to the inquiry that are associated with each other. However, the information to be notified by the notification information 600 in the embodiment is not limited to the inquiry and the answer to the inquiry, and may include additional information in another embodiment.

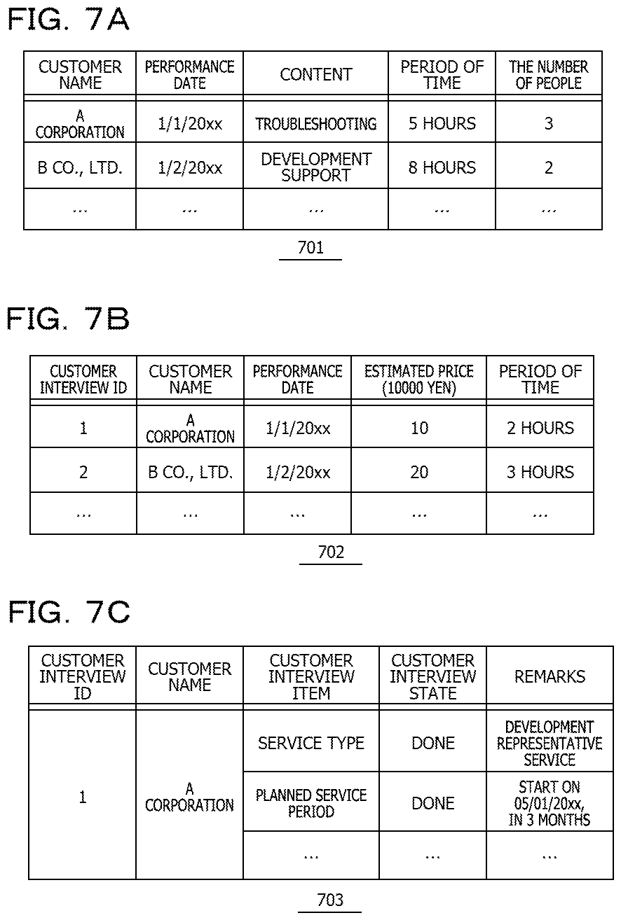

FIG. 7 (i.e., FIGS. 7A and 7B) is a diagram illustrating additional information 900 according to the embodiment, as an example. FIG. 7A is a diagram illustrating the on-site support information 701 in which information about the on-site support service performed for the customer is registered, as an example. For example, in the on-site support information 701 in FIG. 7A, a performance date of the on-site support performed for the customer, the content of the support, a period of time taken for the support, and the number of support people who performed the support are registered in association with the customer name.

FIG. 7B is a diagram illustrating the customer interview information 702 in which information about a customer interview performed by the support service provision vendor for the customer is registered, as an example. For example, in the customer interview information 702 in FIG. 7B, the customer name of the customer whom the customer interview has been performed, a performance date of the customer interview, an estimated price for the support service determined in the customer interview, and a period of time taken for the customer interview are registered in association with a customer interview ID. The customer interview ID is, for example, an identifier for identifying each performed customer interview.

FIG. 7C is a diagram illustrating the customer interview content information 703 according to the embodiment, as an example. For example, information collected in the customer interview to be identified by the customer interview ID is registered in the customer interview content information 703. For example, in FIG. 7C, in the customer interview content information 703, information about a customer interview item, a customer interview state, and remarks are registered in association with the customer interview ID and the customer name. The customer interview item may be information indicating, for example, target information to be collected in the customer interview, and the customer interview state may be information indicating whether or not the collection of the target information indicated in the customer interview item has been performed. In the remarks, for example, information obtained by collecting the target information indicated in the customer interview item may be registered.

For example, as illustrated in FIG. 7A to FIG. 7C, the support service provision vendor stores, in the storage unit 302, information about the on-site support, the customer interview, and the like that have been performed as the support service by the support service provision vendor. Thus, for example, when notifying the customer of the notification information 600, the control unit 301 may further cause information included in the on-site support information 701, the customer interview information 702, and the customer interview content information 703 to be included in the notification information 600 and notify the customer of the notification information 600. Thus, the support server 205 may provide the content of the support service received by the customer to the customer in a form that may be visualized in more detail.

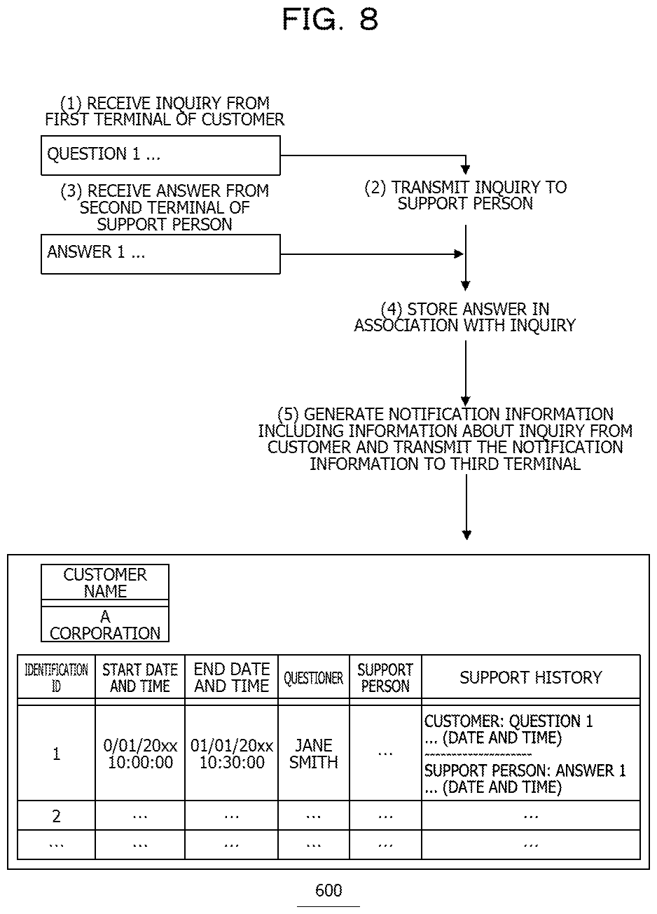

FIG. 8 is a diagram illustrating a procedure of processing of providing a support service to be executed by the control unit 301 of the support server 205 according to the embodiment described above, as an example.

As illustrated in FIG. 8, the control unit 301 of the support server 205 receives, for example, an inquiry from the first terminal 201 ((1) in FIG. 8). The control unit 301 transmits the received inquiry to the support person ((2) in FIG. 8). For example, the control unit 301 may transmit inquiry information including the received inquiry to the second terminal 202 that is used by the support person.

Subsequently, the control unit 301 receives an answer to the notified inquiry from the second terminal 202 that is used by the support person ((3) in FIG. 8). The control unit 301 stores the received answer in association with the inquiry ((4) in FIG. 8). For example, the control unit 301 may register a record in which the notified inquiry and the received answer are associated with each other in the support history information 500 and store the record in the storage unit 302.

For example, the control unit 301 extracts information about the record related to the inquiry received from the customer from the support history information 500, generates notification information 600, and transmits the generated notification information 600 to the third terminal 203 ((5) in FIG. 8).

Thus, for example, the evaluator who evaluates the value of the support service for the customer may refer to the notification information 600 and receive the presentation of the content of the support received from the support service.

For example, when the notification information 600 includes information about an immediate answer rate, the evaluator of the support service may evaluate how quick the support is provided in response to the inquiry based on the immediate answer rate.

In the above-described embodiment, the immediate answer rate is exemplified as an index for evaluating the support service, but the index for evaluating the support service is not limited thereto. In another embodiment, as the index for evaluating the support service, the control unit 301 may use, for example, a statistical value such as an average period of time that it takes to receive answer information including a first answer to the inquiry received from the customer.

Although an embodiment has been exemplified above, the embodiment is not limited thereto. For example, the operation processing described above are exemplary, and the embodiment is not limited thereto. When possible, the order of performing the processes in the operation processing may be changed, the operation processing may further include a different process, or some of the processes in the operation processing may be omitted. For example, in one embodiment, the step of evaluating the support service in S408 in FIG. 4 may be omitted.

For example, in a case where the inquiry received from the customer is unclear, a message may be exchanged between the customer and the support person a plurality of times in order for the support person to correctly recognize the content of the inquiry. In this case, a message returned first in response to the inquiry may not be an answer to the inquiry but may be a message for confirming the content of the inquiry. In another embodiment, when the support person transmits an official answer to the inquiry to the support server 205 via the second terminal 202, the support person may add additional information indicating the answer to a reply message. Thus, when the additional information is added to the reply message, the control unit 301 of the support server 205 may determine that the received reply message is the answer corresponding to the inquiry. In this case, the control unit 301 may use a time when the reply message in which the additional information is added is received as a time when the answer is received.

In the above-described embodiment, an example is illustrated in which an inquiry and an answer to the inquiry are exchanged between the first terminal 201 and the second terminal 202 via the support server 205. However, the embodiment is not limited thereto. For example, the support person who provides the support service may provide the support service by directly communicating between the first terminal 201 and the second terminal 202 through functions such as an e-mail, a telephone call, a voice call via an application, a video call, screen sharing, and the like. Also in this case, for example, after providing the support service, the support person who has the second terminal 202 may notify the support server 205 of the content of the provided support service as answer information, thereby executing the above-described embodiment.

Alternatively, the second terminal 202 may collect information about the support provided to the customer from data of an application used to provide the support service, and notify the support server 205 of the information as the answer information. As an example, the second terminal 202 may include an agent that monitors an e-mail application. For example, the agent may refer to data of the e-mail application including e-mails exchanged with the first terminal 201 of the customer, and may extract an e-mail including the answer corresponding to the inquiry from an e-mail address of the customer that is a destination and contents such as a title of the e-mail and the like. The second terminal 202 may generate answer information including the title and the content of a message body of the extracted e-mail and may notify the support server 205 of the answer information. Thus, even when the support service is directly provided from the second terminal 202 to the first terminal 201 via the e-mail, the support server 205 may collect the content of the support service provided to the customer.

In the above-described embodiment, for example, in the processing of S402, the control unit 301 of the support server 205 operates as the notification unit 311. In the processing of S406, the control unit 301 of the support server 205 operates as the saving unit 312, for example. In the processing of S409, the control unit 301 of the support server 205 operates as the transmission unit 313, for example.

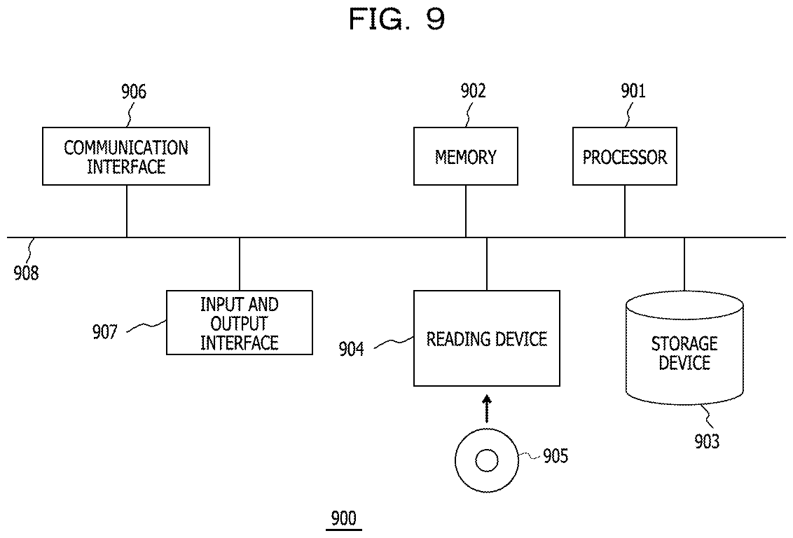

FIG. 9 is a diagram illustrating a hardware configuration of a computer 900 for achieving the support server 205 according to the embodiment, as an example. The computer 900 is an information processing apparatus, for example. The hardware configuration of the computer 900 in FIG. 9 includes, for example, a processor 901, a memory 902, a storage device 903, a reading device 904, a communication interface 906, and an input and output interface 907. The processor 901, the memory 902, the storage device 903, the reading device 904, the communication interface 906, and the input and output interface 907 are coupled to each other via a bus 908, for example.

The processor 901 may be a single processor, a multiprocessor, or a multicore processor, for example. The processor 901 uses the memory 902 to execute a program in which the procedures of the above-described operation processing are described, thereby providing some or all of the above-described functions of the control unit 301, for example. For example, the processor 901 of the support server 205 reads and executes a program stored in the storage device 903, thereby operating as the notification unit 311, the saving unit 312, and the transmission unit 313.

The memory 902 is, for example, a semiconductor memory and may include a RAM area and a ROM area. The storage device 903 is, for example, a hard-disk drive, a semiconductor memory such as a flash memory or the like, or an external storage device. RAM is an abbreviation for a random-access memory. ROM is an abbreviation for a read-only memory.

The reading device 904 accesses a removable storage medium 905 in accordance with an instruction of the processor 901. The removable storage medium 905 is implemented by, for example, a semiconductor device, a medium to and from which information is input and output by a magnetic action, a medium to and from which information is input and output by an optical action, or the like. The semiconductor device is, for example, a Universal Serial Bus (USB) memory. The medium to and from which information is input and output by the magnetic action is, for example, a magnetic disk. The medium to and from which information is optically input and output is, for example, a CD-ROM, a DVD, a Blu-ray Disc, or the like (Blu-ray is a registered trademark). CD is an abbreviation for a compact disc. DVD is an abbreviation for a Digital Versatile Disk.

The storage unit 302 may include the memory 902, the storage device 903, and the removable storage medium 905, for example. For example, the storage device 903 of the support server 205 stores the support history information 500, the notification information 600, the on-site support information 701, the customer interview information 702, and the customer interview content information 703. For example, the processor 901 of the support server 205 may generate the notification information 600 from the support history information 500.

The communication interface 906 communicates with other apparatuses such as the first terminal 201, the second terminal 202, and the third terminal 203 in accordance with an instruction from the processor 901. The communication interface 906 is, for example, an example of the above-described communication unit 303.

The input and output interface 907 may be, for example, an interface between an input device and an output device. The input device is, for example, a device such as a keyboard, a mouse, a touch panel, or the like that receives an instruction from a user. The output device is, for example, a display device such as a display and an audio device such as a speaker.

Each program according to the embodiment is provided in the support server 205, for example, in the following form.

(1) The program is installed in advance, in the storage device 903.

(2) The program is provided by a removable storage medium 905.

(3) The program is provided from a server such as a program server.

The hardware configuration of the computer 900 for implementing the support server 205 described with reference to FIG. 9 is an example, and the embodiment is not limited thereto. For example, a part of the above-described configuration may be deleted, and a new configuration may be added. In another embodiment, for example, some or all of the functions of the control unit 301 described above may be implemented as hardware such as an FPGA, an SoC, an ASIC, a PLD, or the like. FPGA is an abbreviation for a field-programmable gate array. SoC is an abbreviation for a system-on-a-chip. ASIC is an abbreviation for an application-specific integrated circuit. PLD is an abbreviation for a programmable logic device.

In an example, the other apparatuses such as the first terminal 201, the second terminal 202, and the third terminal 203 described above may have the hardware configuration of the computer 900 in FIG. 9.

Some embodiments have been described above. However, the embodiments are not limited to the above-described embodiments. It is to be appreciated that the embodiments include a number of types of variations and alternatives of the above-described embodiments. For example, it would be appreciated that various types of embodiments are able to be embodied by modifying the elements without departing from the scope of the gist of the embodiments. It would also be appreciated that various types of embodiments are able to be implemented by appropriately combining a plurality of the elements disclosed according to the above-described embodiment. Also, one skilled in the art would appreciate that various types of embodiments are able to be implemented by deleting an element or elements from the elements described according to the embodiment or adding an element or elements to the elements described according to the embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing an information processing program for causing a computer to execute processing, the processing comprising:
notifying a second terminal of inquiry information that includes an inquiry received from a first terminal;
storing, when an answer to the inquiry information is received from the second terminal, the inquiry and the answer in association with each other in a storage device; and
transmitting notification information that includes the inquiry and the answer in association with each other to a third terminal different from the first terminal and the second terminal.

2. The non-transitory computer-readable storage medium according to claim 1, the process further comprising:
transmitting answer information that includes the answer to the first terminal.

3. The non-transitory computer-readable storage medium according to claim 1, wherein
the transmitting is configured to transmit, to the third terminal, the notification information that includes time information that indicates an answer period of time that it takes to make the answer from the reception of the inquiry.

4. The non-transitory computer-readable storage medium according to claim 1, the process further comprising:
causing the computer to execute receiving a completion notification that closes the inquiry from the first terminal, wherein
the transmitting is configured to transmit, to the third terminal, the notification information that includes time information that indicates an answer period of time that it takes to close the inquiry from the reception of the inquiry.

5. The non-transitory computer-readable storage medium according to claim 3, wherein
the notification information includes a plurality of inquiries received from a customer who uses the first terminal, answers individually corresponding to the plurality of inquiries, and individual pieces of the time information associated with the plurality of inquiries, and
the transmitting is further configured to transmit, to the third terminal, an immediate response rate that indicates a rate of the number of an inquiry or inquiries whose time information is within a predetermined period of time among the plurality of inquiries.

6. The non-transitory computer-readable storage medium according to claim 1, wherein
the storing, when an additional inquiry related to the inquiry, or an additional answer, from the second terminal, related to the inquiry, or a combination thereof is received, is further configured to store the additional inquiry, or the additional answer, or the combination thereof in association with the inquiry in the storage device.

7. A computer-based method comprising:
notifying a second terminal of inquiry information that includes an inquiry received from a first terminal;
storing, when an answer to the inquiry information is received from the second terminal, the inquiry and the answer in association with each other in a storage device; and
transmitting notification information that includes the inquiry and the answer in association with each other to a third terminal different from the first terminal and the second terminal.

8. An information processing apparatus comprising:
a memory; and
a processor coupled to the memory, the processor being configured to perform processing, the processing including:
notifying a second terminal of inquiry information that includes an inquiry received from a first terminal;
storing, when an answer to the inquiry information is received from the second terminal, the inquiry and the answer in association with each other in a storage device; and
transmitting notification information that includes the inquiry and the answer in association with each other to a third terminal different from the first terminal and the second terminal.
